(19) United States
(12) Patent Application Publication
(10) Pub. No.: US 2009/0171768 A1
(43) Pub. Date: Jul. 2, 2009

(54) METHOD AND SYSTEM FOR INCENTIVE BASED TIE-IN TRANSACTION

(76) Inventors: ARJUN CHOPRA, Brookline, MA (US); SUNDAR SUBRAMANIAM, Cambridge, MA (US)

Correspondence Address: GLOBAL IP SERVICES, PLLC, 10 CRESTWOOD LANE, NASHUA, NH, 03062, US

(21) Appl. No.: 12/343,490

(22) Filed: Dec. 24, 2008

Related U.S. Application Data
(60) Provisional application No. 61/016,600, filed on Dec. 26, 2007.

(51) Int. Cl. G06Q 30/00

(52) U.S. Cl. 705/10; 705/26; 705/14

(57) ABSTRACT

A method and system for incentive based tie-in transaction is disclosed. In one embodiment, an e-commerce system embedded with a transaction engine performs a method of an e-commerce transaction, the method including displaying multiple sale items on a website, and forwarding offering data which proposes a deal for a first item in exchange for a participation in one or more tie-in offers to an electronic device of a user upon receiving request data for purchasing the first item from the electronic device of the user, where the tie-in offers are selected from multiple registered offers based on transaction data associated with the user using the transaction engine. The method further includes forwarding receipt data confirming a sale of the first item to the electronic device of the user in response to a purchase signal triggered by the electronic device of the user.

### RELATED APPLICATIONS

Benefit is claimed under 35 U.S.C. 119(e) to U.S. Provisional Applications Ser. No. 61/016,600 entitled “products provided in exchange for commitment to purchase” by Arjun Chopra et al.,filed on 26 Dec. 2007, which is herein incorporated in its entirety by reference for all purposes.

### FIELD OF TECHNOLOGY

Embodiments of the present invention relate to the field of electronic commerce (e-commerce). More particularly, embodiments of the present invention relate to a transaction method and system of e-commerce.

### BACKGROUND

A transaction is an agreement, communication, or movement carried out between separate entities or objects, often involving an exchange of items of value, such as information, goods, services and/or money. For example, a user may visit an e-commerce website or web portal to check out a good or service offered by a vendor or vendors serviced by the website. Then, as the user finds an item the user likes to purchase, he or she may make a purchase by clicking the item displayed on the website and by making a payment for the item via a transaction system, which may be embedded on the website.

However, if the user wants to purchase diverse items, the user may have to visit several websites. For instance, if the user were to purchase a song to download, an IPOD, a T-shirt, and a gift card (or a gift certificate) from a coffee shop, the user may have to visit an on-line music store, electronic store, clothing shop, and coffee shop, respectively. Although there may be a website which offers a large number of items, the website may not have all the items that the user may wish to purchase. This, in turn, may cause the user to spend lots of time searching for items of his or her interest as well as good deals for such items.

### SUMMARY

A method and system for incentive based tie-in transaction is disclosed. In one aspect, a method includes receiving request data for purchasing a first item from an electronic device of a user via a website of a first vendor, and forwarding offering data which proposes a deal for the first item in exchange for a participation in one or more tie-in offers to the electronic device of the user, where the tie-in offers are selected from multiple registered offers based on transaction data of the user. The method further includes forwarding receipt data confirming a sale of the first item to the website of the first vendor in response to a purchase signal triggered by the electronic device of the user. The method may also include forwarding flag data confirming the participation in the tie-in offers by the user to respective communication devices for respective vendors of the one or more tie-in offers, and forwarding second acknowledgement data for the participation in the tie-in offers to the electronic device of the user.

In another aspect, an e-commerce system embedded with a transaction engine performs a method of an e-commerce transaction, the method includes displaying multiple sale items on a website, and forwarding offering data which proposes a deal for a first item in exchange for a participation in one or more tie-in offers to an electronic device of a user upon receiving request data for purchasing the first item from the electronic device of the user, where the tie-in offers are selected from multiple registered offers based on transaction data associated with the user using the transaction engine. The method further includes forwarding receipt data confirming a sale of the first item to the electronic device of the user in response to a purchase signal triggered by the electronic device of the user.

The methods, and/or systems disclosed herein may be implemented by any means for achieving various aspects, and may be executed in a form of a machine readable medium embodying a set of instructions that, when executed by a machine, cause the machine to perform any of the operations disclosed herein.

### BRIEF DESCRIPTION OF THE DRAWINGS

Embodiments of the present invention are illustrated by way of an example and not limited to the figures of the accompanying drawings, in which like references indicate similar elements and in which:

FIGS. 1A through 1H illustrate an exemplary e-commerce transaction, according to one embodiment;

FIG. 2A is a data flow diagram which illustrates an operation of a transaction engine embedded in an e-commerce system, according to one embodiment;

FIG. 2B illustrates exemplary elements of transaction data of FIG. 2A, according to one embodiment; and

FIG. 3 illustrates a process flow chart of an exemplary method for an e-commerce transaction, according to one embodiment.

Other features of the present embodiments will be apparent from the accompanying drawings and from the detailed description that follows.

### DETAILED DESCRIPTION

A method and system for incentive based tie-in transaction is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

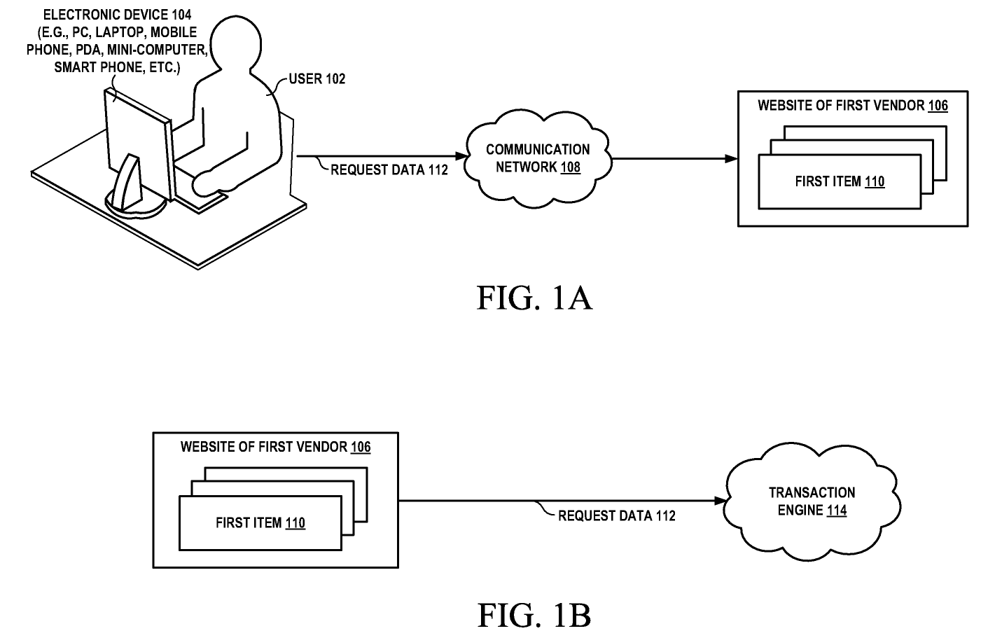

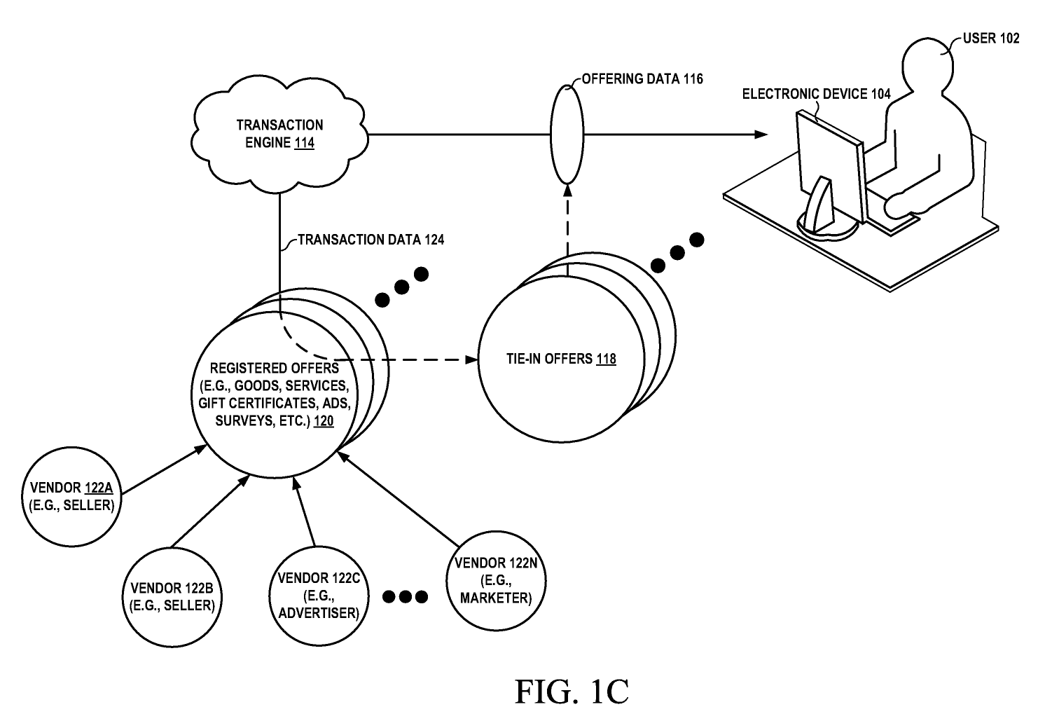

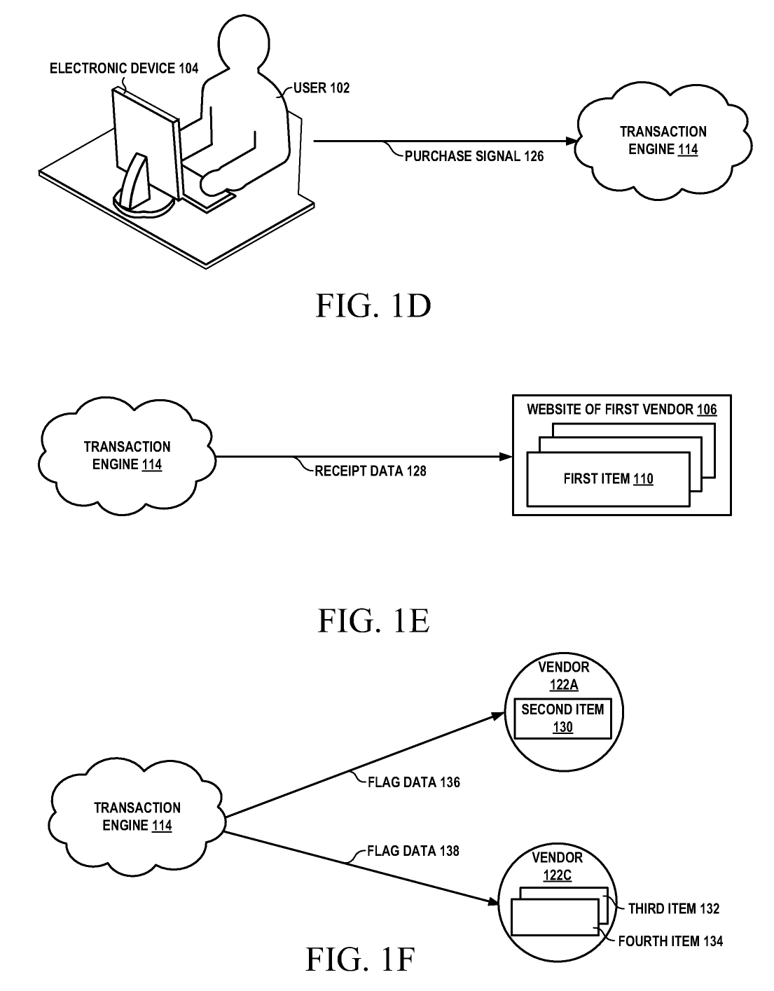

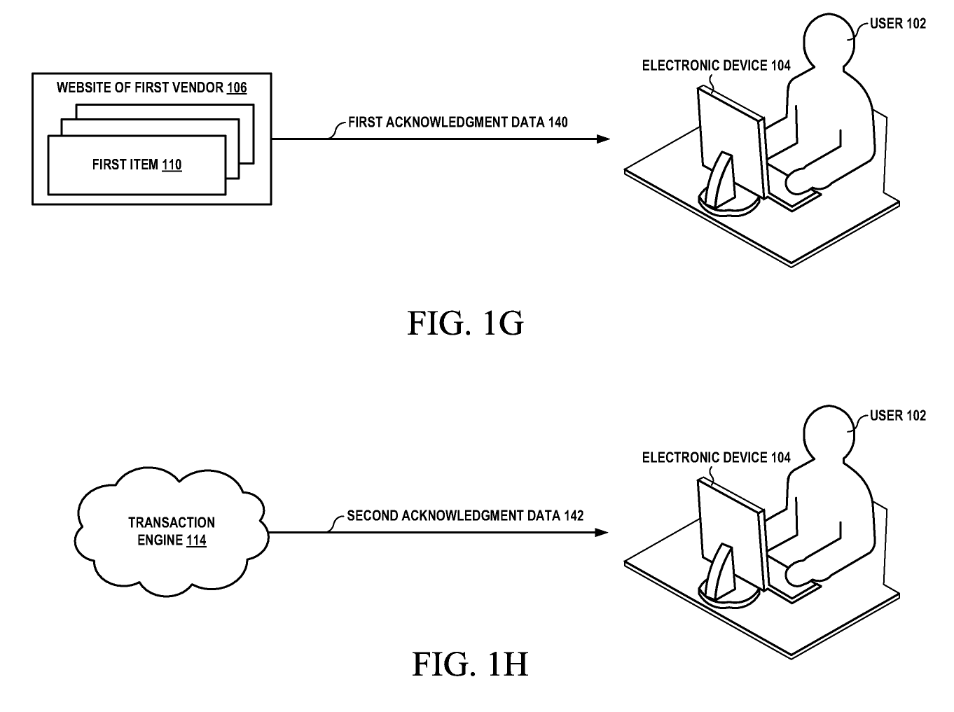

FIGS. 1A through 1H illustrate an exemplary e-commerce transaction, according to one embodiment. Particularly, FIG. 1A illustrates receiving request data 112 from a user 102 for purchasing a first item 110. It can be seen from FIG. 1A that the first item 110 is exhibited on a website of first vendor 106 through which the first item 110 may be purchased. In one embodiment, the request data 112 is received from an electronic device 104 of the user 102, which may include a personal computer (PC), a laptop, a mobile phone, an automated phone system, a personal digital assistant (PDA), a smart phone, or a mini-computer. As shown in FIG. 1A, the website of first vendor 106 and the electronic device 104 of the user 102 are coupled using a communication network 108 which includes the Internet, a cellular network, and/or a telephone network.

Upon receiving the request data 112 from the electronic device 104 of the user 102, the request data 112 along with other information is sent to a transaction engine 114 (e.g., a transaction module, a transaction system, etc.), as shown in FIG. 1B. In one embodiment, the request data 112 is sent from the website of first vendor 106 to the transaction engine 114 to query for deals to offer to the user 102. In this embodiment, the transaction engine 114 forwards offering data 116 to the electronic device 104 of the user 102, as shown in FIG. 1C. The offering data 116 proposes a deal for the first item 110 in exchange for a participation in one or more tie-in offers 118. In one exemplary implementation, the deal for the first item 110 includes an offer of the first item 110 for free or at a discount in exchange for the participation in the tie-in offers 118. For example, the user 102 may be offered a free downloadable song in exchange for a purchase of a ten dollar gift certificate or card for a coffee store chain. In another example, the website of the first vendor 106 may offer to receive donations on behalf of the user. In this case, the user 102 may purchase a ten dollar gift certificate or card for a coffee store chain and a one dollar donation is made to the website of vendor 106 on the user 102's behalf.

Further, the offering data 116 may include a donation to a charity chosen by the user 102 in exchange for a purchase of the first item 110 and/or the participation in the tie-in offers 118. Thus, if the user 102 were to purchase the downloadable song and/or the ten dollar gift certificate in the example above, a small proceed (e.g., 3 percent) from the purchased amount may be donated to a charity designated by the user 102. As shown in FIG. 1C, the tie-in offers 118 are selected from multiple registered offers 120. The registered offers 120 may be a gift certificate or gift card, a good, a service, an advertisement, and/or a survey offered by vendors 122A through 122N based on transaction data 124 of the user 102. In one example, the tie-in offers 118 include a purchase of a gift card, a good, and/or a service in exchange for the first item 110. In another example, the tie-in offers 118 include viewing of one or more advertisements in exchange for the deal for the first item 110. In yet another example, the tie-in offers 118 include answering to one or more surveys in exchange for the deal for the first item 110. In one exemplary implementation, the transaction data 124 includes user data, demographic information, previous purchasing history, commission rates of vendors, and sales performances of vendors, where some of the information may have been received as part of the request data 112 and from the website of the first vendor 106.

The user 102 may then choose one of the offering data 116 and make a purchase by triggering a purchase signal 126 from the electronic device 104 of the user 102. It can be seen from FIG. 1D that, the purchase signal 126 triggered upon making the purchase is sent to the transaction engine 114. The transaction engine 114 then forwards receipt data 128 to the website of first vendor 106, as shown in FIG. 1E, in response to the purchase signal 126 triggered by the electronic device 104 of the user 102. The receipt data 128 may include confirmation of payment, and the website of the first vendor 106 may then deliver the first item 110 to the electronic device 104 of the user 102.

Further, the transaction engine 114 forwards flag data confirming a sale of the one or more tie-in items 118 by the user 102 to respective communication devices for respective vendors of the tie-in items 118. For example, as shown in FIG. 1F, flag data 136 is forwarded to the vendor 122A that confirms a sale of a second item 130 and flag data 138 is forwarded to the vendor 122C that confirms viewing of a third item 132 and a fourth item 134.

Furthermore, the website of first vendor 106 forwards first acknowledgement data 140 for the sale of the first item 110 to the electronic device 104 of the user 102, as shown in FIG. 1G. Also, the transaction engine 114 forwards second acknowledgment data 142 for the participation in the tie-in offers 118 to the electronic device 104 of the user 102, as shown in FIG. 1H.

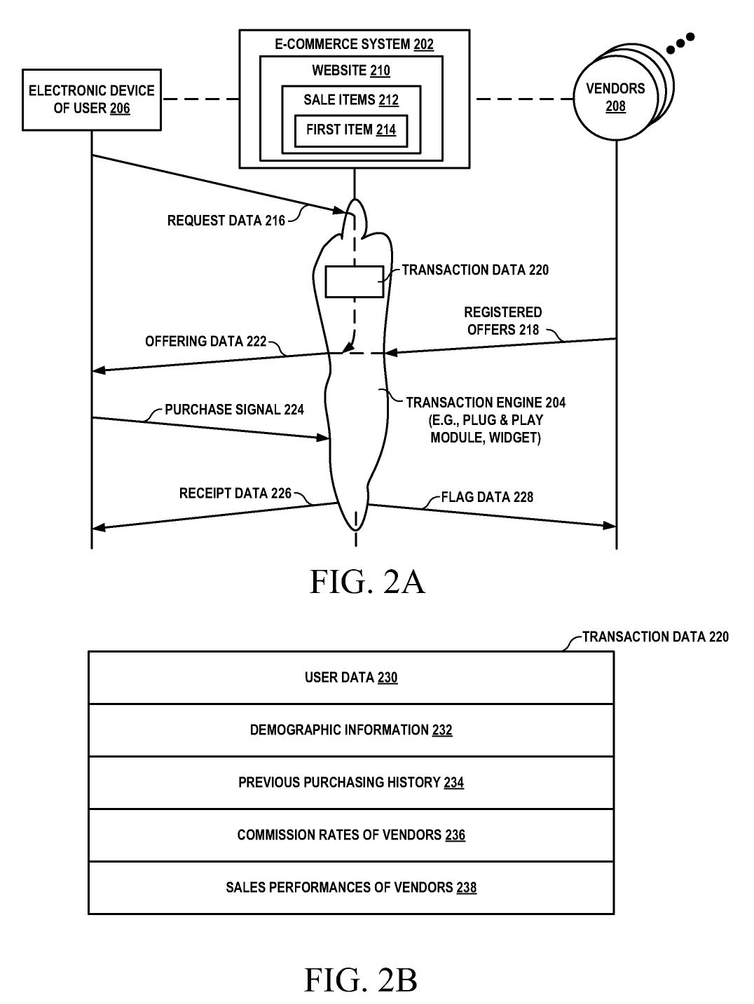

FIG. 2A is a data flow diagram 200 which illustrates an operation of a transaction engine 204 embedded in an e-commerce system 202, according to one embodiment. The e-commerce system 202 may be represented by a web portal which offers one or more deals associated with goods and/or services. In the embodiment, the transaction engine 204 may be embedded in the web portal. In an alternative embodiment, the transaction engine 204 may be implemented as a separate module or system. It is appreciated that the transaction engine 204 is an exemplary embodiment of the transaction engine 114 of FIGS. 1A through 1H. Particularly, FIG. 2A illustrates the e-commerce system 202, the transaction engine 204, an electronic device of user 206, and a group of vendors 208 offering multiple registered e-commerce items 218 (e.g., a gift certificate, a good, a service, an advertisement, a survey, etc.), and a website 210 which offers one or more deals associated with goods and/or services, including donations.

In operation, the user of the e-commerce system 202 sends request data 216 from the electronic device of user 206 to purchase a first item 214 (e.g., a desired good, a desired service, a donation to a charity, etc.), where the first item 214 may be one item from numerous sale items 212 displayed on the website 210. Based on the request data 216 and transaction data 220 (e.g., which includes user data, demographic information, previous purchasing history, etc.), the transaction engine 204 may forward offering data 222 to the electronic device of user 206. The offering data 222 proposes a deal for the first item 214 in exchange for a participation in one or more tie-in offers. The tie-in offers may include a purchase of a tie-in item, watching an advertisement, answering a survey, etc. The one or more tie-in offers may be selected from the multiple registered offers 218 that may be offered by the group of vendors 208 based on the transaction data 220 of the user using the transaction engine 204.

In one embodiment, the user may participate in one or more tie-in offers from registered offers 218 in exchange for a deal associated with the first item 214. As the user confirms acceptance of the deal associated with the first item 214 or the offering data 222, a purchase signal 224 may be triggered by the electronic device of user 206. In response to the purchase signal 224, receipt data 226 is forwarded to the electronic device of user 206 by the transaction engine 204 confirming a sale of the first item 214. Further, flag data 228 confirming the participation of the user in the tie-in offers is forwarded to respective vendors of the tie-in offers through respective communication devices by the transaction engine 204, as shown in the data flow diagram 200 of FIG. 2A.

In one example embodiment, the transaction engine 204 may be based on a plug and play module. Alternatively, the transaction engine 204 may be in a form of a widget which is transferable and embedded into other websites (or web pages) or devices by a drag-and-drop action.

FIG. 2B illustrates exemplary elements of the transaction data 220 of FIG. 2A, according to one embodiment. In one exemplary implementation, the transaction data 220 is taken into consideration by the transaction engine 204 for choosing the offering data 222 to forward to the user. The transaction data 220 includes user data 230, demographic information 232, previous purchasing history 234, commission rates of vendors 236, and sales performances of vendors 238, as illustrated in FIG. 2B. In one example embodiment, the user data 230 may include information about the user, who purchases the first item 214 as shown in FIG. 2A, such as personal details, interests, likes, dislikes, etc.

The demographic information 232 may include statistical characteristics (e.g., age, location, etc.) of a group of users similar to the user described in FIG. 2A. The previous purchasing history 234 includes details regarding previous purchases of the user in the e-commerce system 202 of FIG. 2A. The previous purchasing history 234 may also include information on which tie-in offers have been accepted by the user in the past. For instance, if the user happens to prefer a certain type of tie-in offers (e.g., taking a survey, watching an advertisement, etc.), the user would be presented with the particular tie-in offers. The commission rates of vendors 236 may include details such as commission rates or discounts received from the vendors 208 by the transaction engine 204. For example, items associated with vendors offering more discounts may be preferred than other items and may be accordingly offered to the users by the transaction engine 204. Further, the sales performances of vendors 238 may include information regarding sale of items or goods from the vendors 208 (e.g., which vendor sells more items, etc.).

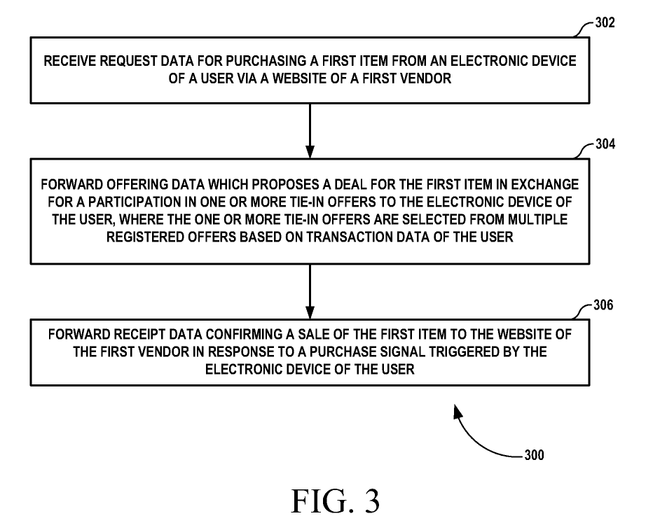

FIG. 3 illustrates a process flow chart 300 of an exemplary method for an e-commerce transaction, according to one embodiment. In step 302, request data for purchasing a first item is received from an electronic device of a user via a website of a first vendor. In one embodiment, the electronic device may comprise a personal computer (PC), a laptop, a mobile phone, a personal digital assistant (PDA), a smart phone, a minicomputer, etc. Additionally, the website of the first vendor and the electronic device of the user may be coupled using the Internet, a cellular network, and/or a telephone network.

In step 304, offering data which proposes a deal for the first item in exchange for a participation in one or more tie-in offers is forwarded to the electronic device of the user, where the one or more tie-in offers are selected from multiple registered offers, such as gift certificates, goods, services, an advertisement, a survey, etc., offered by a group of vendors (e.g., sellers, advertisers, marketing companies, etc.) based on transaction data of the user. In one embodiment, the deal for the first item may include an offer of the first item for free or at a discount in exchange for the participation in the tie-in offers. Additionally, the offering data may comprise a donation to a charity designated by the user in exchange for the purchase of the first item and/or the participation in the tie-in offers. In one exemplary implementation, the transaction data may include user data, demographic information of other users similar to the user, previous purchasing history of the user, respective commission rates paid by the vendors, and/or sales performances of the vendors.

In step 306, receipt data confirming a sale of the first item is forwarded to the website of the first vendor in response to a purchase signal triggered by the electronic device of the user. In one embodiment, the website of the first vendor may be prompted to forward acknowledgement data for the sale of the first item to the electronic device of the user. Additionally, flag data confirming the participation of the user in the tie-in items may be forwarded to communication devices (e.g., a mobile phone, computer, etc.) of vendors of the tie-in offers. Furthermore, acknowledgement data for the participation of the user in the tie-in offers may be forwarded to the electronic device of the user as well. It is appreciated that the method illustrated in FIG. 3 may be implemented by a computer readable medium for an e-commerce transaction having instructions that, when executed by a computer, cause the computer to perform the method illustrated in FIG. 3.

The above-described transaction engine allows users to choose from a range of products and services to purchase, as alternatives to making a contribution to an original vendor from whom a product or service is received. The above-described transaction engine can be embedded into any website or device. Also, the above-described transaction engine can be delivered as a mobile phone application, or even built directly into hardware of a device. Further, the above-described transaction engine can be taken by a user and embedded into the user's own website, thereby enabling viral distribution. It should be noted that, the above-described method and system may be extended for digital products such as music, video, text, news, etc. and for any physical asset a vendor might wish to sell or offer services around too.

It is appreciated that, the transaction engine presents the user with a range of options to enter into a commitment to purchase (e.g., via a gift certificate), instead of just the products being offered by the vendors. When the user purchases the gift certificate offered by the transaction system, a percentage of the transaction is sent to the original vendor, and the purchased product or service is then made available to the user. The above-described transaction reflects commitment of the user (directly or over the Internet or a phone) to buy goods at face value or greater/lesser value at some point of time in the future. The user will receive goods at the face value or higher (in the event that the gift certificate is sold at a discount to the face value).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. A method for an e-commerce transaction, comprising:
receiving request data for purchasing a first item from an electronic device of a user via a website of a first vendor;
forwarding offering data which proposes a deal for the first item in exchange for a participation in at least one tie-in offer to the electronic device of the user, wherein the at least one tie-in offer is selected from a plurality of registered offers by a plurality of vendors based on transaction data of the user; and
forwarding receipt data confirming a sale of the first item to the website of the first vendor in response to a purchase signal triggered by the electronic device of the user.

2. The method of claim 1, wherein the deal for the first item comprises an offer of the first item for free or at a discount.

3. The method of claim 1, wherein the offering data further comprises a donation to a charity chosen by the user in exchange for a purchase of the first item or the participation in the at least one tie-in offer.

4. The method of claim 1, wherein the at least one tie-in offer comprises a purchase of a tie-in item and a performance of a task.

5. The method of claim 1, wherein the tie-in item comprises a gift certificate, a good, and a service.

6. The method of claim 1, wherein the performance of the task comprises watching at least one advertisement and answering at least one survey.

7. The method of claim 1, wherein the transaction data comprises user data, demographic information of other users similar to the user, previous purchasing history of the user, respective commission rates paid by the plurality of vendors, and sales performances of the plurality of vendors.

8. The method of claim 1, wherein the website of the first vendor is prompted to forward first acknowledgement data for the sale of the first item to the electronic device of the user.

9. The method of claim 1, further comprising forwarding flag data confirming the participation of the user in the at least one tie-in offer to respective communication devices for respective vendors of the at least one tie-in offer.

10. The method of claim 1, further comprising forwarding second acknowledgement data for the participation of the user in the at least one tie-in offer to the electronic device of the user.

11. An e-commerce system embedded with a transaction engine for performing a method of an e-commerce transaction, the method comprising:
displaying a plurality of sale items on a website;
forwarding offering data which proposes a deal for a first item in exchange for a participation in at least one tie-in offer to an electronic device of a user upon receiving request data for purchasing the first item from the electronic device of the user, wherein the at least one tie-in offer is selected from a plurality of registered offers based on transaction data associated with the user using the transaction engine; and
forwarding receipt data confirming a sale of the first item to the electronic device of the user in response to a purchase signal triggered by the electronic device of the user.

12. The system of claim 11, wherein the electronic device comprises a personal computer (PC), a laptop, a mobile phone, a personal digital assistant (PDA), a smart phone, and a mini-computer.

13. The system of claim 11, wherein the website and the electronic device of the user are coupled using a communication network which includes the Internet, a cellular network, and a telephone network.

14. The system of claim 11, wherein the transaction engine is based on a plug and play module.

15. The system of claim 11, wherein the transaction engine is in a form of a widget which is transferrable to another website by a drag-and-drop or copy and paste action.

16. The system of claim 11, wherein the first item comprises a desired good, a desired service, and a donation to a charity.

17. The system of claim 11, wherein the transaction data comprises user data, demographic information of other users similar to the user, previous purchasing history of the user, respective commission rates paid by the plurality of vendors, and sales performances of the plurality of vendors.

18. The system of claim 11, wherein the registered offers comprise a gift certificate, a good, a service, an advertisement, and a survey.

19. The system of claim 11, wherein flag data confirming the participation of the user in the at least one tie-in offer is forwarded to respective communication devices for respective vendors of the at least one tie-in offer.

20. A computer readable medium for an e-commerce transaction having instructions that, when executed by a computer, cause the computer to perform a method comprising:
receiving request data for purchasing a first item from an electronic device of a user via a website of a first vendor;
forwarding offering data which proposes a deal for the first item in exchange for a participation in at least one tie-in offer to the electronic device of the user, wherein the at least one tie-in offer is selected from a plurality of registered offers by a plurality of vendors based on transaction data of the user; and
forwarding receipt data confirming a sale of the first item to the website of the first vendor in response to a purchase signal triggered by the electronic device of the user.
